(19) United States
(12) Patent Application Publication
(10) Pub. No.: US 2019/0276150 A1
(43) Pub. Date: Sep. 12, 2019

(54) HEADREST COVER HOLDER SYSTEM

(71) Applicant: Lascelles Cotterell, Pickering (CA)

(72) Inventor: Lascelles Cotterell, Pickering (CA)

(21) Appl. No.: 15/914,105

(22) Filed: Mar. 7, 2018

(51) Int. Cl. B64D 11/00; B64D 11/06

(52) U.S. Cl. CPC B64D 11/00152; B64D 11/0605; B64D 11/0629

(57) ABSTRACT

A headrest cover holder system having a sleeve configured to be removably installed on a headrest of a seat on a passenger-vehicle. The sleeve includes an electronic device mount allowing a passenger to mount an electronic-device to a rear-side of the headrest. Adjustable angle setting may be included for optimized comfort during use. The device may also include a padded front-surface and functional indicia.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of storage and mounting devices and more specifically relates to a storage device attachable to a headrest.

### 2. Description of Related Art

People often travel using bus, train and airplane. As a form of entertainment to help pass time, some buses, trains and airplanes have incorporated built-in video entertainment units. Many buses, trains and airplanes now incorporate individual entertainment units for each passenger, which are often located in the upper seatbacks of passenger seats. However, often only a limited number of programming options are available on such displays. Personal electronic devices, such as tablets, computers, smartphones and mobile gaming platforms, offer additional entertainment options in comparison to the individual entertainment units. Personal electronic devices usually allow a user to store and customize their own content, so that they are not limited to the content then-stored in an individual entertainment unit. Unfortunately, a user must hold a personal electronic device in one's hands or place it on a fold-down tray table. Holding a personal electronic device for extended periods can lead to fatigue and discomfort. The use of a tray table may not provide an optimum viewing angle, and in any event, the tray table is often occupied during in-transit meals or unable to use due the seatbelt indictor light is on during flight which passengers still desire the use of their personal electronic devices. A suitable solution is desired.

U.S. Pub. No. 2015/0123433 to John S. Lamb, Jr. relates to a holder for personal electronic devices. The described holder for personal electronic devices includes a display apparatus for the presentation to a user of a personal electronic device (PED), including a horizontal flexible member effective for the insertion of a portion of a PED so that the display of the PED is orientated towards a user. The disclosed apparatus is useful in conjunction with passenger seating within a passenger vehicle, such as an aircraft. In some embodiments, an adjustment mechanism allows for adjustment of the orientation of the display of the PED.

### BRIEF SUMMARY OF THE INVENTION

In view of the foregoing disadvantages inherent in the known storage and mounting device art, the present disclosure provides a novel headrest cover holder system. The general purpose of the present disclosure, which will be described subsequently in greater detail, is to provide a headrest mount for personal electronic devices such as tablets or phones.

A headrest cover holder system is disclosed herein. The headrest cover holder system includes a sleeve having a closed top-end, an open bottom-end, a front-surface, a rear-surface including at least one cut-out, and an electronic device mount, and a fastener (means). The sleeve comprises the closed top-end, the open bottom-end, the front-surface, the rear-surface, and the fastener in functional combination. The sleeve is configured to be removably installed on a headrest of a seat on a passenger-vehicle. The front-surface is positioned on a front-side of a headrest, the closed top-end is positioned on a top of the headrest, and the rear-surface is positioned adjacent a rear-side of the headrest during an in-use condition. The electronic device mount is configured to receive an electronic-device such as a tablet or mobile-phone for removable use. The electronic device mount is adjustable and includes adjustable angle settings allowing a user to adjust an angle of the electronic-device mounted within the electronic device mount. The device allows a user to store or mount an electronic-device for use on an airplane or other passenger-vehicle while still having access to a compartment or a tray on a backside of the seat of the passenger-vehicle.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a headrest cover holder system, constructed and operative according to the teachings of the present disclosure.

FIG. 1 is a perspective view of the headrest cover holder system during an ‘in-use’ condition, according to an embodiment of the disclosure.

FIG. 2A is a perspective view of the headrest cover holder system of FIG. 1, according to an embodiment of the present disclosure.

FIG. 2B is a perspective view of the headrest cover holder system of FIG. 1, according to an embodiment of the present disclosure.

FIG. 3 is a perspective view of the headrest cover holder system of FIG. 1, according to an embodiment of the present disclosure.

FIG. 4 is a perspective view of the headrest cover holder system of FIG. 1, according to an embodiment of the present disclosure.

FIG. 5 is a perspective view of the headrest cover holder system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a storage and mounting device and more particularly to a headrest cover holder system as used to improve the storage and mounting of a personal electronic device on a headrest.

Generally, the invention is a sleeve or headrest cover for a seat on a bus, train or airplane that holds a tablet or other electronic device. Passengers no longer have use a folding tray behind an aircraft seat to place their electronic device. The headrest cover holder system includes a leather/vinyl (or other suitable material for hygienic cleaning) sleeve that may be placed over the headrest. The device includes a padded cushion on a front side for additional comfort and relaxation for passengers. The headrest cover holder system provides hands free comfort for passengers and eliminated the need to share a folding tray with beverages/food. A user no longer needs to use one's lap/knees or hands as a placeholder for an electronic device. The device may be used with any type of BLUETOOTH® device on buses, trains and airplanes with the folding tray acting as a desk/placeholder. Adjustable angle settings may be provided for various viewing. The device maintains full access to a screen, and all universal ports, speakers, microphones, cameras on an electronic device.

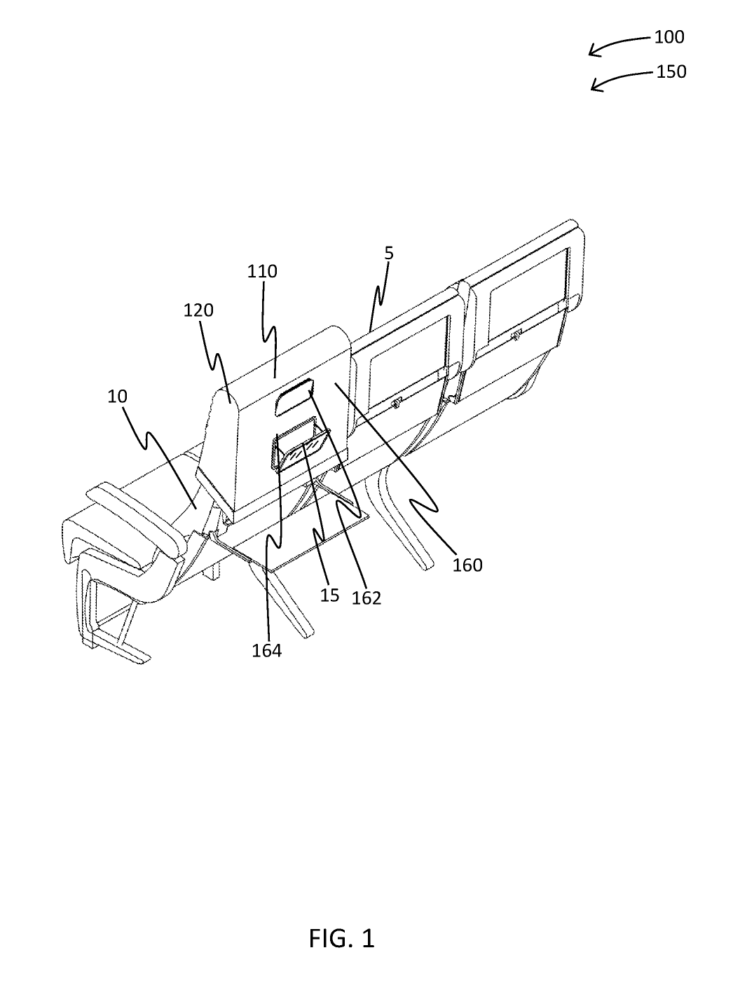

Referring now more specifically to the drawings by numerals of reference, there is shown in FIGS. 1-5, various views of a headrest cover holder system 100. FIG. 1 shows a headrest cover holder system 100 during an ‘in-use’ condition 150, according to an embodiment of the present disclosure. As illustrated, the headrest cover holder system 100 may include a sleeve 110 having a closed top-end 120, an open bottom-end 124, a front-surface 130, a rear-surface 160 including at least one cut-out 162, and an electronic device mount 164, and a fastener 166. The sleeve 110 comprises the closed top-end 120, the open bottom-end 124, the front-surface 130, the rear-surface 160, and the fastener 166 in functional combination. The sleeve 110 is configured to be removably installed on a headrest 5 of a seat 10 on a passenger-vehicle.

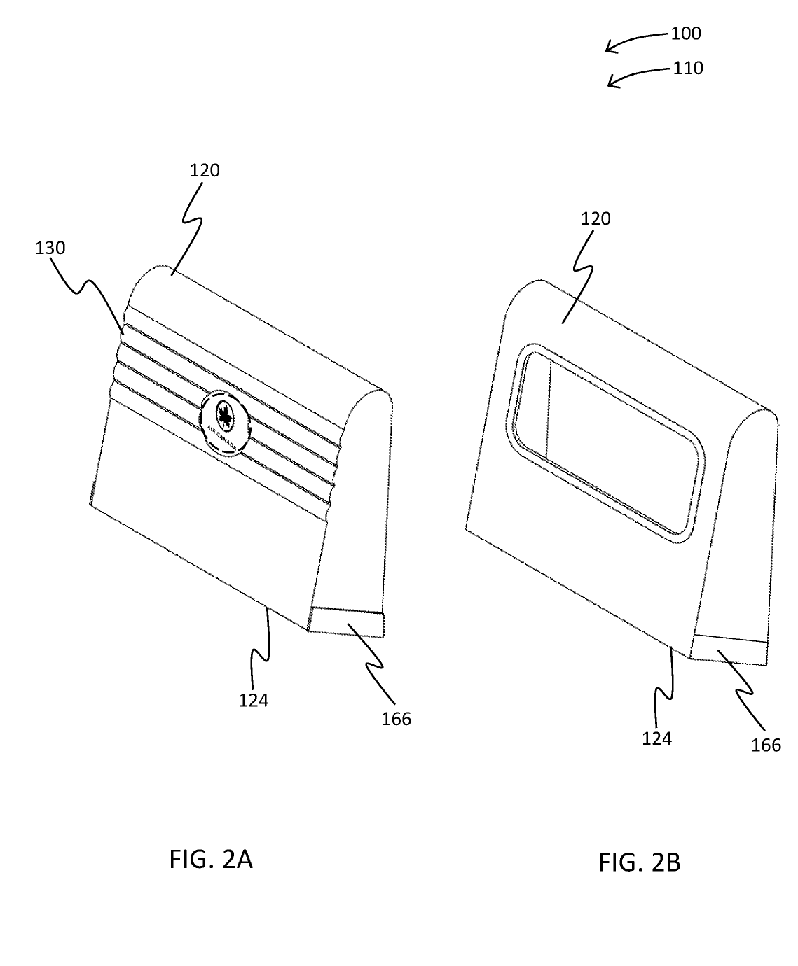

FIGS. 2A and 2B show a perspective views of the headrest cover holder system 100 of FIG. 1, according to an embodiment of the present disclosure. As above, the headrest cover holder system 100 may include the sleeve 110 having the closed top-end 120, the open bottom-end 124, the front-surface 130, the rear-surface 160 including at least one cut-out 162, and the electronic device mount 164, and the fastener 166. The front-surface 130 is positioned on a front-side of a headrest 5, the closed top-end 120 is positioned on a top of the headrest 5, and the rear-surface 160 is positioned adjacent a rear-side of the headrest 5 during an in-use condition. As shown in FIG. 2B, the sleeve 110 may include a stretchable and expandable material to allow the device to retro-fit a head rest wing of certain aircraft chairs that have a head rest wing. Therefore, passengers have access to the head rest wing for adjusting side flaps of the head rest wing.

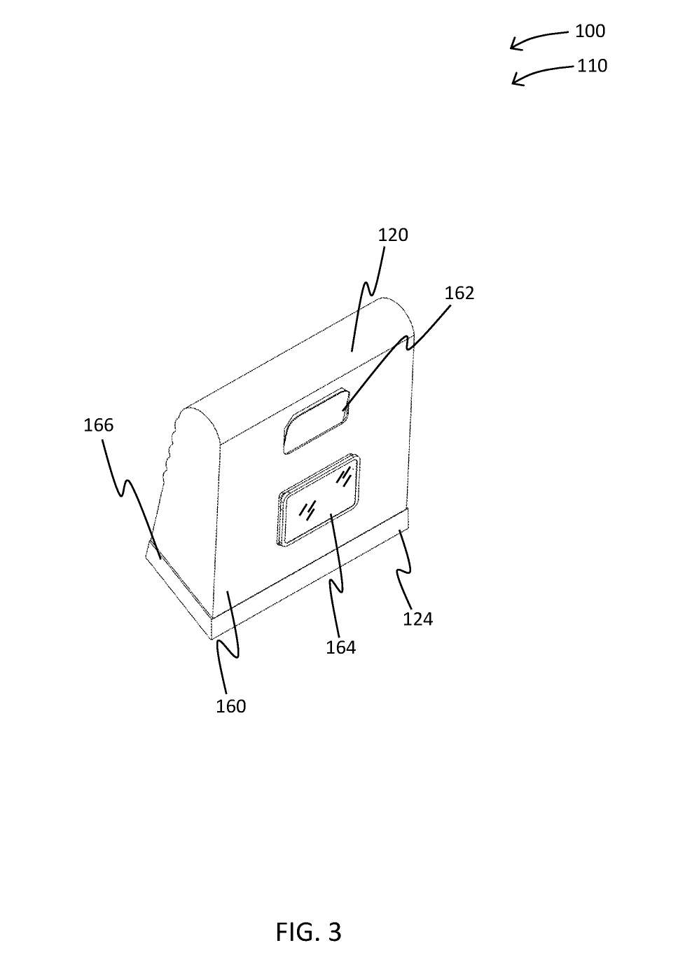

Referring now to FIG. 3 showing a perspective view of the headrest cover holder system 100 of FIG. 1, according to an embodiment of the present disclosure. As above, the headrest cover holder system 100 may include the sleeve 110. The sleeve 110 is flexible and comprises washable material such as leather, vinyl, or other suitable material allowing the device to be cleaned and wiped down to maintain hygiene. The sleeve 110 includes a continuous piece of fabric encasing a right-side of the headrest, a left-side of the headrest, and the top of the headrest 5. The fastener 166 of the sleeve 110 comprises an elastic-fastener configured to secure the sleeve 110 to the seat 10 of the passenger-vehicle.

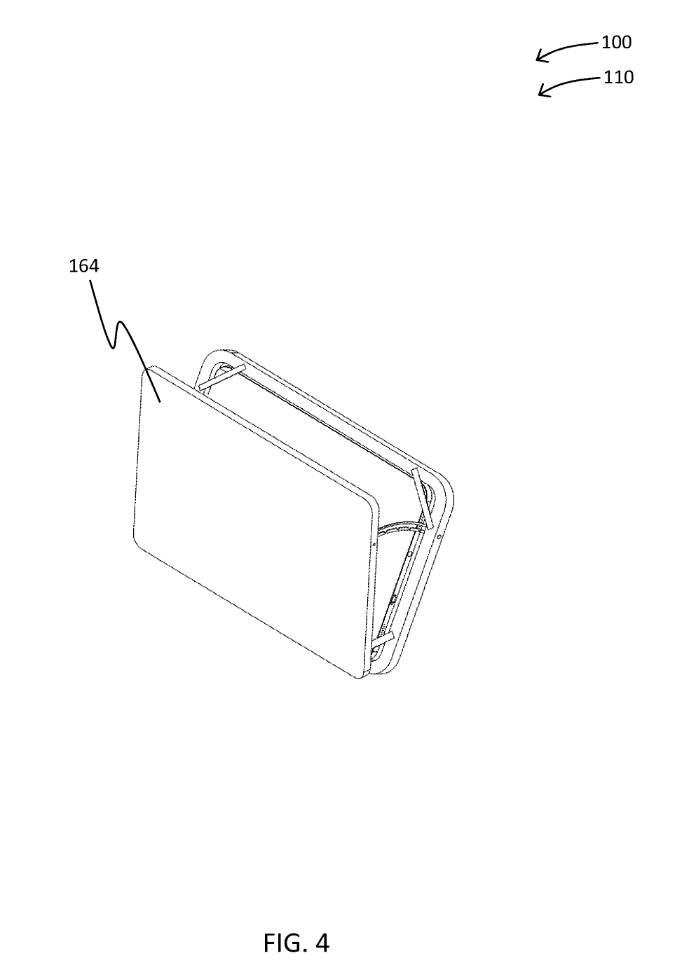

FIG. 4 shows a perspective view of the headrest cover holder system 100 of FIG. 1, according to an embodiment of the present disclosure. As above, the headrest cover holder system 100 may include the sleeve 110 having the closed top-end 120, the open bottom-end 124, the front-surface 130, the rear-surface 160 including at least one cut-out 162, and the electronic device mount 164, and the fastener 166. The sleeve 110 configured to be removably installed on a headrest 5 of a seat 10 on a passenger-vehicle. The sleeve 110 is retrofittable to a variety of the passenger-vehicles. In a preferred embodiment, the passenger-vehicle comprises an airplane, bus, train or other passenger-vehicle. The open bottom-end 124 is configured to rest above a tray on the backside of the seat 10 of the passenger-vehicle and not extend past the tray. The at least one cut-out 162 is configured to provide access to items stored on a backside of the seat 10 on the passenger-vehicle such as an emergency card holder on an airplane. The at least one cut-out 162 is positioned above the electronic device mount 164. The at least one cut-out 162 comprises a substantially rectangular profile.

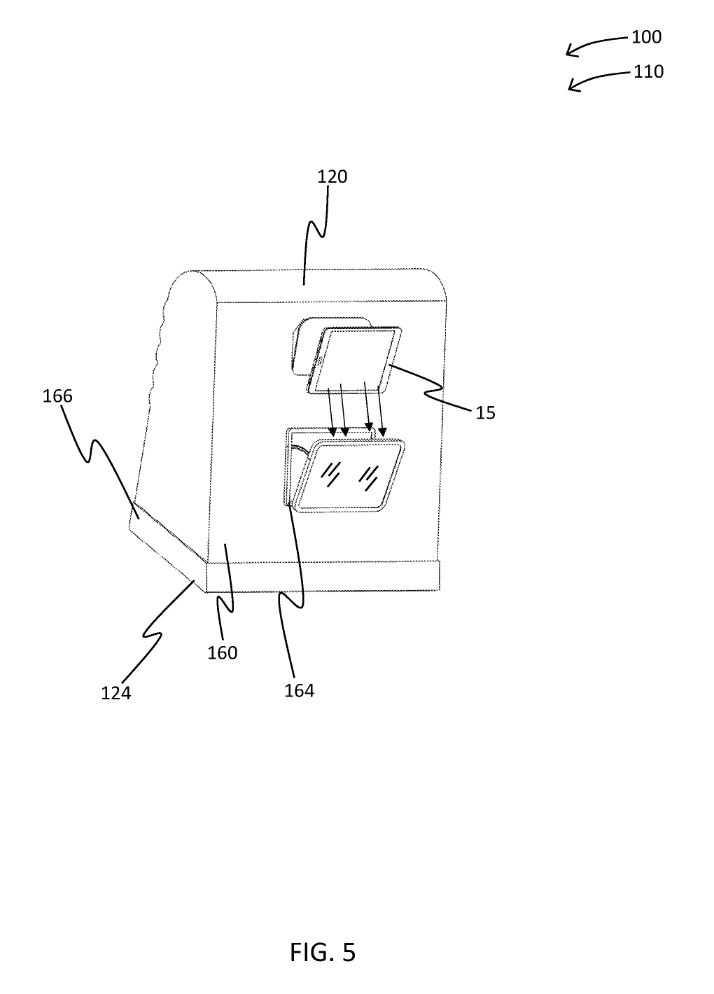

Referring now to FIG. 5 showing a perspective view of the headrest cover holder system 100 of FIG. 1, according to an embodiment of the present disclosure. As above, the headrest cover holder system 100 may include the sleeve 110 having the closed top-end 120, the open bottom-end 124, the front-surface 130, the rear-surface 160 including at least one cut-out 162, and the electronic device mount 164, and the fastener 166. The front-surface 130 further comprises padding or a cushion to promote comfort of a passenger while seated with the device installed on the headrest 5 and a portion of a seat-back. The front-surface 130 may comprise functional indicia. The functional indicia may include advertising, company logos, or other desired indicia. The electronic device mount 164 is configured to receive an electronic-device 15 such as a tablet or mobile-phone for removable use. The electronic device mount 164 is adjustable and includes adjustable angle settings allowing a user to adjust an angle of the electronic-device 15 mounted within the electronic device mount 164.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A headrest cover holder system comprising:
a sleeve having;
a closed top-end;
an open bottom-end; and
a front-surface;
a rear-surface including;
at least one cut-out; and
and an electronic device mount; and
a fastener;
wherein said sleeve comprises said closed top-end, said open bottom-end, said front-surface, said rear-surface, and said fastener in functional combination;
wherein said sleeve is configured to be removably installed on a headrest of a seat on a passenger-vehicle;
wherein said front-surface is positioned on a front-side of a headrest, said closed top-end is positioned on a top of said headrest, and wherein said rear-surface is positioned adjacent a rear-side of said headrest during an in-use condition;
wherein said at least one cut-out is configured to provide access to items stored on said seat on said passenger-vehicle;
wherein said electronic device mount is adjustable to a desired viewing angle;
wherein said electronic device mount is configured to receive an electronic-device for removable use.

2. The headrest cover holder system of claim 1, wherein said sleeve is retrofittable to a variety of said passenger-vehicles.

3. The headrest cover holder system of claim 1, wherein said electronic device mount comprises adjustable angle settings.

4. The headrest cover holder system of claim 3, wherein said adjustable angle settings allows a user to adjust said electronic-device to an angle between approximately 0 degrees and 45 degrees.

5. The headrest cover holder system of claim 1, wherein said electronic-device comprises a tablet.

6. The headrest cover holder system of claim 1, wherein said electronic-device comprises a mobile-phone.

7. The headrest cover holder system of claim 1, wherein said passenger-vehicle comprises an airplane.

8. The headrest cover holder system of claim 1, wherein said at least one cut-out is positioned above said electronic device mount.

9. The headrest cover holder system of claim 8, wherein said at least one cut-out is configured to provide access to an emergency card holder on a backside of said seat of said passenger-vehicle.

10. The headrest cover holder system of claim 9, wherein said open bottom-end is configured to rest above a tray on said backside of said seat of said passenger-vehicle and not extend past said tray.

11. The headrest cover holder system of claim 1, wherein said at least one cut-out comprises a substantially rectangular profile.

12. The headrest cover holder system of claim 1, wherein said sleeve comprises washable material.

13. The headrest cover holder system of claim 1, wherein said washable material is selected from the group consisting of leather and vinyl.

14. The headrest cover holder system of claim 1, wherein said fastener comprises an elastic-fastener configured to secure said sleeve to said seat of said passenger-vehicle.

15. The headrest cover holder system of claim 1, wherein said front-surface further comprises padding.

16. The headrest cover holder system of claim 15, wherein said front-surface comprises functional indicia.

17. The headrest cover holder system of claim 1, wherein said sleeve is flexible.

18. The headrest cover holder system of claim 17, wherein said sleeve comprises a continuous piece of fabric encasing a right-side of said headrest, a left-side of said headrest, and said top of said headrest.

19. A headrest cover holder system, the headrest cover holder system comprising:
a sleeve having;
a closed top-end;
an open bottom-end; and
a front-surface;
a rear-surface including;
at least one cut-out; and
and an electronic device mount; and
a fastener;
wherein said sleeve comprises said closed top-end, said open bottom-end, said front-surface, said rear-surface, and said fastener in functional combination;
wherein said sleeve is configured to be removably installed on a headrest of a seat on a passenger-vehicle;
wherein said sleeve is retrofittable to a variety of said passenger-vehicles;
wherein said sleeve comprises washable material;
wherein said sleeve is flexible;
wherein said passenger-vehicle comprises an airplane;
wherein said front-surface is positioned on a front-side of a headrest, said closed top-end is positioned on a top of said headrest, and wherein said rear-surface is positioned adjacent a rear-side of said headrest during an in-use condition;
wherein said front-surface further comprises padding;
wherein said sleeve comprises a continuous piece of fabric encasing a right-side of said headrest, a left-side of said headrest, and said top of said headrest;
wherein said at least one cut-out is configured to provide access to items stored on said seat on said passenger-vehicle;
wherein said at least one cut-out is positioned above said electronic device mount;
wherein said at least one cut-out is configured to provide access to an emergency card holder on a backside of said seat of said passenger-vehicle;
wherein said open bottom-end is configured to rest above a tray on said backside of said seat of said passenger-vehicle and not extend past said tray;
wherein said at least one cut-out comprises a substantially rectangular profile;
wherein said electronic device mount is configured to receive an electronic-device for removable use;
wherein said electronic device mount is adjustable;
wherein said electronic device mount comprises adjustable angle settings;
wherein said adjustable angle settings allows a user to adjust said electronic-device to an angle between approximately 0 degrees and 45 degrees;
wherein said fastener comprises an elastic-fastener configured to secure said sleeve to said seat of said passenger-vehicle.
